(19) United States
(12) Patent Application Publication
(10) Pub. No.: US 2009/0321183 A1
(43) Pub. Date: Dec. 31, 2009

(54) ACOUSTIC PANEL

(75) Inventors: Mark Johnson, Breslau (CA); Hugh Howie, Ayr (CA)

Correspondence Address: VALENTINE A COTTRILL;SUSAN TANDAN, 50 QUEEN STREET NORTH, STE. 1020, P.O. BOX 2248, KITCHENER, ON, N2H6M2, CA

(73) Assignee: CAMALI INDUSTRIES (NA) INC., Cambridge (CA)

(21) Appl. No.: 12/147,949

(22) Filed: Jun. 27, 2008

(51) Int. Cl. E04B 1/82; B32B 37/00

(52) U.S. Cl. 181/290; 156/60

(57) ABSTRACT

An acoustic panel for muffling sound. The acoustic panel includes one or more fiberglass mats and an outer layer with a substantially smooth surface. The acoustic panel also includes one or more adhesive elements for securing the outer layer to a selected side of the fiberglass mat to position the substantially smooth surface of the outer layer facing away from the fiberglass mat.

### FIELD OF THE INVENTION

The present invention relates to an acoustic panel for muffling sound.

### BACKGROUND OF THE INVENTION

Known acoustic panels (i.e., panels used in office partitions and the like) have been determined to have unacceptably high levels of chemical and particle emissions (e.g., formaldehyde).

For instance, the GreenGuard Environmental Institute has established performance standards to define goods with acceptably low chemical and particle emissions for use indoors. Among other things, the standards establish certification procedures, including test methods, allowable emissions levels, product sample collection and handling, testing type and frequency, and program application and acceptance processes.

In compliance with such standards, products are to be tested in dynamic environmental chambers following ASTM standards D-511-97 and D-6670-01, which are the United States Environmental Protection Agency's testing protocol for furniture and the protocol established by the State of Washington for interior furnishings and construction materials. Products are measured for emission levels, which must not exceed specified indoor air concentrations within five days of unpacking. For instance, air concentrations are measured on the following basis. The product is positioned in a room having a volume of 32 cubic meters of air in it, with an outdoor air concentration of 0.8 air changes per hour (ACH).

Maximum allowable emission levels, depending on the situation, are selected by GreenGuard from a variety of sources. For example, the maximum allowable emission levels may be those required by the State of Washington's indoor air quality program for new construction; the U.S. EPA's procurement specifications; recommendations of the World Health Organization; and/or the Blue Angel program (originating in Germany) for electronic equipment. Where multiple emission values are recommended, the most stringent of such values is used as the acceptable emission value for GreenGuard certification. Many U.S. companies now insist that their suppliers be GreenGuard certified, so that their employees will have safe working conditions. However, the acoustic panels of the prior art generally have unacceptable levels of free state formaldehyde.

In addition, due to the prior art manufacturing methods and materials, current acoustic panels typically have a finish that is not smooth enough for the fine finish fabrics and the new lamination process being utilized by the office furniture industry at present. Visible surface irregularities, typical in the prior art acoustic panels, are not acceptable.

### SUMMARY OF THE INVENTION

For the foregoing reasons, there is therefore a need for an improved acoustic panel which addresses or mitigates one or more of the disadvantages of the prior art.

During manufacturing of the panel, layers of woven and/or non-woven materials are laminated together through the use of high heat and specialty polymer adhesives. Controlled heating and compression is applied during manufacturing to provide bonding, stiffness and surface finish.

In its broad aspect, the invention provides an acoustic panel for muffling sound. The acoustic panel includes one or more fiberglass mats and an outer layer with a substantially smooth surface. The acoustic panel also includes one or more adhesive elements for securing the outer layer to a selected side of the fiberglass mat to position the substantially smooth surface of the outer layer facing away from the fiberglass mat.

In another aspect, the fiberglass mat includes one or more materials selected to provide the selected side with a substantially smooth finish.

In yet another aspect, the acoustic panel additionally includes one or more additional fiberglass mats and one or more additional adhesive elements, for securing the additional fiberglass mat to a side of the fiberglass mat which is facing away from the selected side thereof.

In yet another aspect, the acoustic panel additionally includes a cloth layer and one or more cloth layer adhesive elements for securing the cloth layer to the substantially smooth surface of the outer layer.

In another of its aspects, the invention provides a method of forming an acoustic panel for muffling sound. The method includes, first, providing a body portion including one or more fiberglass mats and second, providing one or more outer layers including a fiberglass veil. Finally, the outer layer is secured to the body portion to position a substantially smooth surface of the outer layer facing away from the body portion.

In yet another of its aspects, the invention provides an alternative method of forming an acoustic panel for muffling sound. The method includes, first, providing a number of fiberglass mats, and second, arranging the fiberglass mats in a layered relationship to locate the fiberglass mats in substantially parallel relationships to each other. Next, a number of adhesive elements are positioned between the fiberglass mats respectively, for securing each of the fiberglass mats together in the layered relationship to provide a body portion of the acoustic panel. An outer mat is included in the body portion, the outer mat including one or more materials selected to provide a selected side of the outer mat with a substantially smooth finish. Finally, the outer mat is positioned so that the selected side at least partially defines the body portion.

In yet another of its aspects, the method additionally includes the steps of providing an outer layer comprising a fiberglass veil, and positioning an additional adhesive element between the outer layer and the selected side of the outer mat to secure the outer layer to the outer mat to locate a substantially smooth surface of the outer layer facing away from the outer mat.

### BRIEF DESCRIPTION OF THE DRAWINGS

The invention will be better understood with reference to the attached drawings, in which:

FIG. 1 is a schematic illustration of an embodiment of an acoustic panel of the invention; and

FIG. 2 is a schematic illustration of an alternative embodiment of the acoustic panel of the invention;

FIG. 3 is a flow chart schematically representing an embodiment of a method of the invention;

FIG. 4 is a flow chart schematically representing an alternative embodiment of a method of the invention; and

FIG. 5 is a flow chart schematically representing another alternative embodiment of a method of the invention.

### DETAILED DESCRIPTION

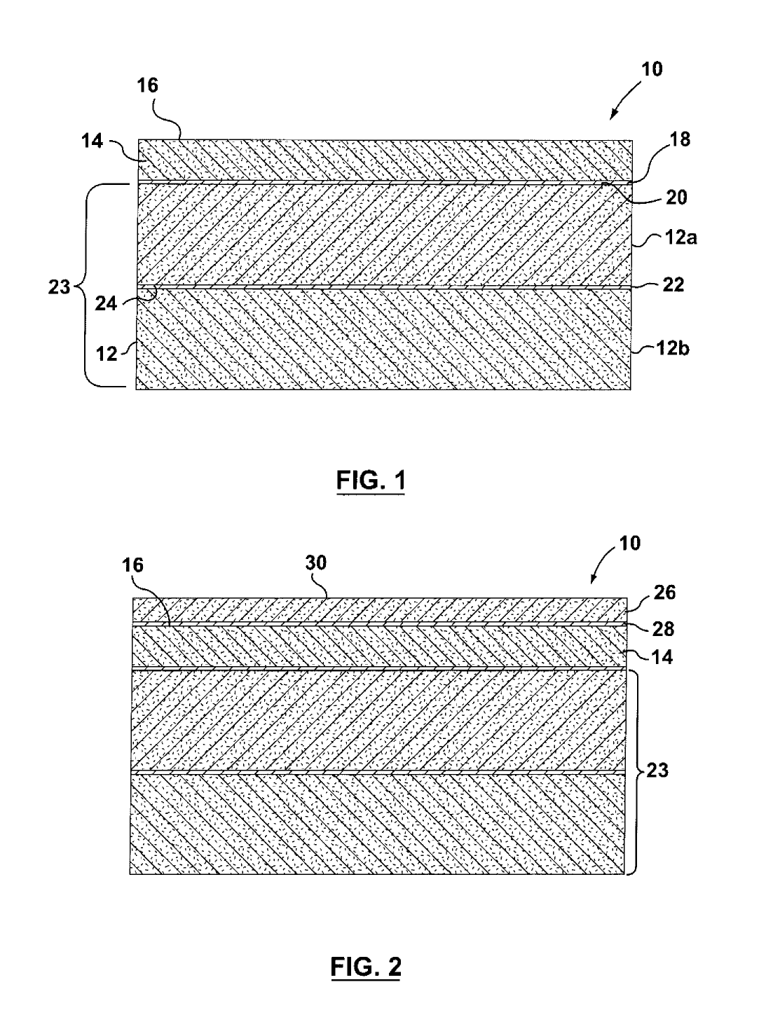

Reference is first made to FIGS. 1 and 2 to describe an embodiment of an acoustic panel 10 adapted for muffling sound. In one embodiment, the acoustic panel 10 includes one or more fiberglass mats 12 and an outer layer 14 having a substantially smooth surface 16. Preferably, the acoustic panel also includes one or more adhesive elements 18 for securing the outer layer 14 to a selected side 20 of the fiberglass mat 12 to position the substantially smooth surface 16 of the outer layer 14 facing away from the fiberglass mat 12 (FIG. 1).

As will be described, the acoustic panel 10 may include any number of fiberglass mats 12. The panel 10 preferably includes three fiberglass mats 12. For convenience, the fiberglass mats 12 are individually identified in FIG. 1 as fiberglass mats 12a and 12b, the outer fiberglass mat being identified as 12b. The fiberglass mats 12 and the adhesive element(s) therebetween form a body portion 23 of the acoustic panel 10. In the acoustic panels of the invention including more than one fiberglass mat, the fiberglass mats are secured together by adhesive elements 22, as will also be described.

Those skilled in the art would be aware of various types of fiberglass mats which would be suitable. In one embodiment, the fiberglass mat 12 preferably is a non-woven continuous strand fiberglass mat.

In one embodiment, the fibreglass mats 12a, 12b preferably are each between about 0.025 inch (0.635 mm.) and about 0.130 inch (3.302 mm.) thick. The adhesive elements preferably are each between about 0.001 inch (0.025 mm.) and about 0.004 inch (0.102 mm.) thick.

It is preferred that the outer layer 14 is a fiberglass veil. As is known in the art, the thickness of the fiberglass veil varies from about 0.015 inch (0.381 mm.) to about 0.035 inch (0.889 mm.). Various fiberglass veil products are available which are suitable. For example, a fiberglass veil known as “CX” mats in which fibers are bonded with latex or PVA (polyvinylalcohol), provided by Owens Corning of Toledo, Ohio, is a suitable fiberglass veil product for the purposes hereof.

In one embodiment, the fibreglass mat 12a preferably includes one or more materials selected to provide the selected side 20 with a substantially smooth finish. Those skilled in the art would be aware of various materials which could provide a substantially smooth finish. Preferably, the fiberglass mat 12a includes a plurality of thermoplastic fibers (not shown). Fiberglass mats with suitable proportions of thermoplastic fibers are known. As will be described, the fibreglass mat 12a preferably is subjected to an appropriate amount of heat and pressure to flatten the thermoplastic fibers to provide the substantially smooth finish. In one embodiment, the fibreglass mat 12a preferably includes PET (polyethylene terephthalate) fibers. Various fiberglass mats including suitable proportions of PET fibers are known. For example, fiberglass mats identified as “8000 series” (e.g., Duraglass 8000) available from Johns Manville of Denver, Colo. are suitable. When the fiberglass mat 12a is subjected to sufficient heat and pressure, the ends of the PET fibers at (or proximal to) the selected side 20 melt, and are pressed into a suitably flat profile, so that the selected side 20 is relatively smooth.

Also, those skilled in the art would be aware of various types of adhesive elements which would be suitable. For instance, various hot melt adhesives (e.g., in the form of granules, tape or webs) may be used. Suitable adhesive products are available from Spunfab, Ltd. of Cuyahoga Falls, Ohio. It has been found that a thin layer of polyethylene (e.g., approximately 0.001 inch (0.0254 mm.) thick), once melted, is a suitable adhesive element.

For example, it has been found that an acoustic panel including three fiberglass mats 12 and the outer layer 14 with polyethylene layers therebetween for adhesive which is held at about 400° F.-450° F. for approximately one minute is properly formed. As indicated above, it is preferred that the outer fiberglass mat 12a includes PET fibers. It will be understood that the outer fibreglass mat 12a may include other types of fibers, e.g., other types of thermoplastic fibers. When the acoustic panel is heated as described above, the PET fibers (and, in particular, the ends thereof) at least partially melt, providing the selected side with the substantially smooth finish. It has also been found that heating the acoustic panel for a period significantly longer than one minute tends to result in “overmelt”. It will be understood that the extent (and duration) of heating is determined on a trial-and-error basis.

If preferred, the acoustic panel is subjected to pressure (i.e., compression). The extent of compression to which the acoustic panel is subjected varies, depending on factors such as the desired thickness and density of the acoustic panel. For instance, the acoustic panel may be compressed between approximately 600 lbs./ft.² (approximately 28,728 Pa.) and approximately 900 lbs./ft.² (approximately 43,092 Pa.) for approximately one minute.

Preferably, and as shown in FIG. 1, the acoustic panel 10 includes an additional (outer) fiberglass mat 12b and an adhesive element 22 for securing the additional fiberglass mat 12b to a side 24 of the fiberglass mat facing away from the selected side 20 thereof.

In one embodiment, the acoustic panel 10 additionally includes a cloth layer 26 and a cloth layer adhesive element 28 for securing the cloth layer 26 to the substantially smooth surface 16 of the outer layer 14 (FIG. 2). The cloth layer 26 preferably provides a substantially uniform exterior surface 30.

In practice, the cloth layer may be applied by a manufacturer other than the manufacturer of the acoustic panel 10. Because various types of cloth may be used as the cloth layer 26, it is preferred that the acoustic panel 10 be designed for use with the type of cloth which is intended to be used as the cloth layer. In general, the finer the cloth, the more the cloth layer brings out imperfections (i.e., irregularities) in the underlying materials. For instance, if the cloth layer 26 is a burlap-like cloth, then the substantially smooth layer 16 of the outer layer 14 does not need to be as smooth as is needed when, for example, the cloth in the cloth layer 14 is a fine linen.

Acoustical properties measured as noise reduction (random incidence) (known as NRC) and sound transmission (known as STC) are controllable variables and may be adjusted according to the end user's requirements through variation of the individual component layers of the panel. Preferably, density and overall thickness of the acoustic panel 10 are varied (or “tuned”) to provide the acoustic panel with the appropriate sound-muffling characteristics for a particular application. For instance, the density of the acoustic panel generally is between approximately 6 lbs./ft³ (approximately 96 kg./m³) and approximately 8 lbs./ft³ (approximately 128 kg./m³). Also, the overall thickness of the panel generally is between approximately 0.130 inch (3.302 mm.) and approximately 0.250 inch (6.35 mm.).

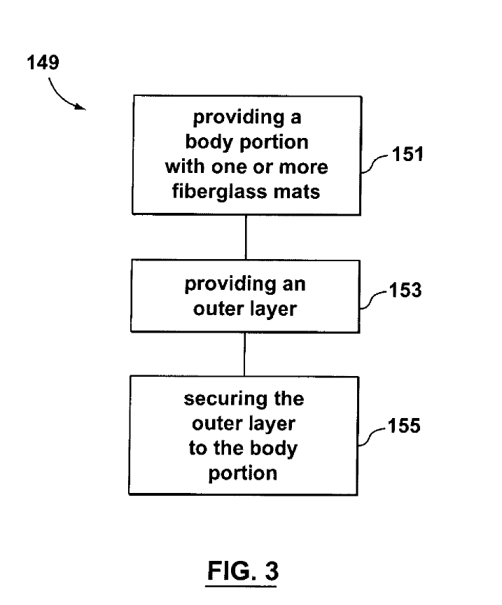

In use, in a first step of an embodiment of a method 149 of the invention, the body portion 23 including one or more fiberglass mats 12 is provided (step 151, FIG. 3). Next, one or more outer layers 14 is provided (step 153). The outer layer preferably is a fiberglass veil. Finally, the outer layer 14 is secured to the body portion 30 to position a substantially smooth surface 16 of the outer layer 14 facing away from the body portion 30 (step 155).

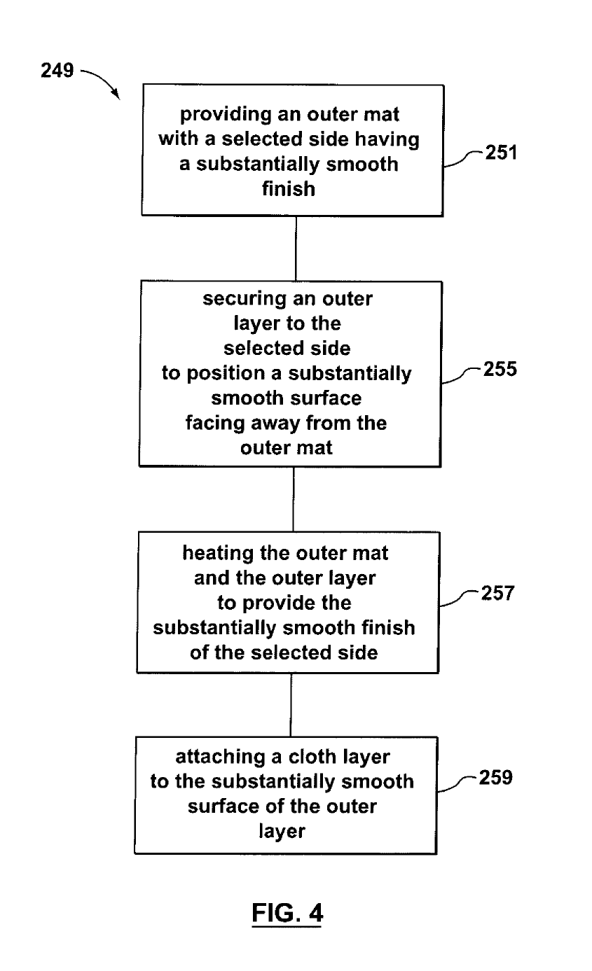

In another embodiment of the method 249 of the invention, the outer mat 12b is provided (step 251, FIG. 4). The outer mat includes one or more materials selected to provide a selected side 20 thereof with a substantially smooth finish. The method preferably also includes securing the outer layer 14 to the selected side 20 of the outer mat 12b to position a substantially smooth surface 16 of the outer layer 14 facing away from the outer mat 12b (step 253). Preferably, the outer layer is subjected to heat and pressure to at least partially melt the material, for providing a substantially smooth finish of the selected side (step 257). The cloth layer 26 preferably is attached to the selected side 20 of the substantially smooth surface 16 of the outer layer 14 to provide a substantially uniform exterior surface 30.

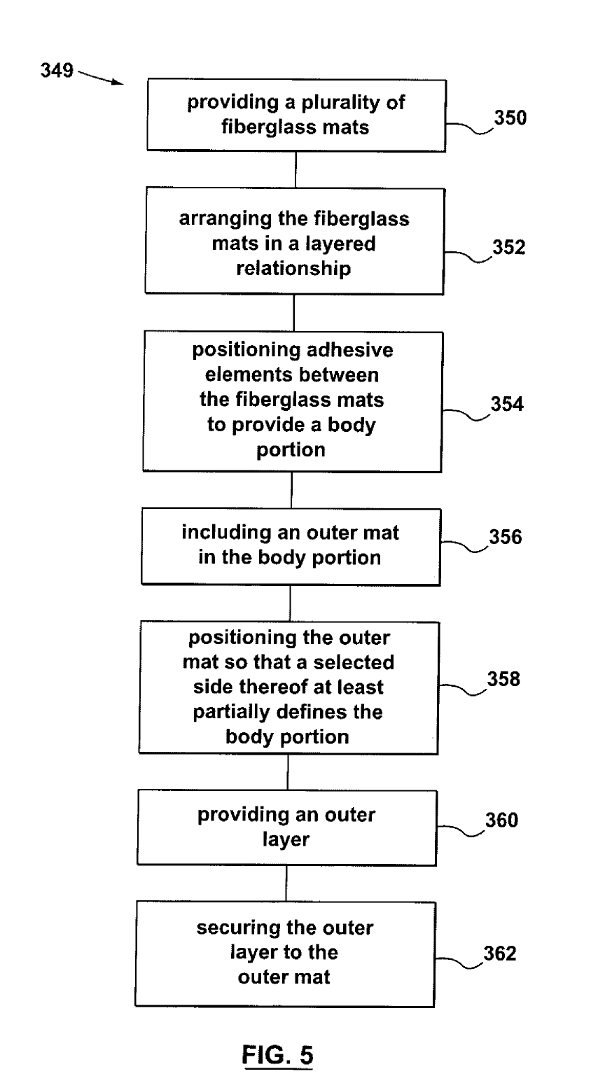

In another embodiment, the method 349 includes, first, providing a number of fiberglass mats (step 350, FIG. 5). Next, the fiberglass mats are arranged in a layered relationship (step 352). Adhesive elements are positioned between the fiberglass mats to provide a body portion of the acoustic panel of the invention (step 354). An outer mat is included in the body portion (step 356). The outer mat is positioned so that a selected side thereof at least partially defines the body portion (step 358). Next, an outer layer is provided (step 360). Finally, the outer layer is secured to the outer mat (step 362).

It will be understood that the order in which the steps of the various embodiments of the method of the invention are performed may be altered somewhat. For example, in method 349, the adhesive elements may be positioned on or between the fiberglass mats before the fiberglass mats are arranged in the layered relationship.

The acoustic panel 10 meets flame and smoke ratings as required under UL 723. In addition, the panel 10 is formaldehyde-free, as measured according to Greenguard standards. From the foregoing, it can be seen that the invention provides relatively smooth surfaces on which successively thinner layers of material are positioned, toward an outer edge of the acoustic panel. For example, in the acoustic panel 10 shown in FIG. 2, the outer layer 14 (preferably, a fibreglass veil) is positioned on the substantially smooth selected side 20 of the outer fibreglass mat 12a. Because the selected side 20 has a substantially smooth finish, it presents few (if any) irregularities to disturb the substantially smooth surface 16 of the outer layer 14. Similarly, because of the relative smoothness of the surface 16, such surface presents few irregularities to disturb the exterior surface 30 of the cloth layer 26. The finish of the panel 10 is exceptionally smooth and substantially free of noticeable surface irregularities. This provides a uniquely smooth surface for lamination of fine cloth fabrics to the panel. Superior dimensional control of end product is realized through the use of waterjet cutting. All three dimensions are “square” and accurate.

Any element in a claim that does not explicitly state “means for” performing a specified function, or “step for” performing a specific function, is not to be interpreted as a “means” or “step” clause as specified in 35 U.S.C. § 112, para. 6.

It will be appreciated by those skilled in the art that the invention can take many forms, and that such forms are within the scope of the invention as claimed. Therefore, the spirit and scope of the appended claims should not be limited to the descriptions of the preferred versions contained herein.

I claim:

1. An acoustic panel for muffling sound, the acoustic panel comprising:
at least one fiberglass mat;
an outer layer comprising a substantially smooth surface; and
at least one adhesive element for securing the outer layer to a selected side of said at least one fibreglass mat to position the substantially smooth surface of the outer layer facing away from said at least one fiberglass mat.

2. An acoustic panel according to claim 1 in which said at least one fiberglass mat is a non-woven continuous strand fiberglass mat.

3. An acoustic panel according to claim 1 in which the outer layer comprises a fiberglass veil.

4. An acoustic panel according to claim 1 in which said at least one fiberglass mat comprises at least one material selected to provide said selected side with a substantially smooth finish.

5. An acoustic panel according to claim 1 additionally comprising:
at least one additional fiberglass mat; and
at least one additional adhesive element, for securing said at least one additional fiberglass mat to a side of said at least one fiberglass mat facing away from said selected side thereof.

6. An acoustic panel according to claim 1 additionally comprising:
a cloth layer; and
at least one cloth layer adhesive element for securing the cloth layer to the substantially smooth surface of the outer layer.

7. An acoustic panel for muffling sound, the acoustic panel comprising:
a first fiberglass mat comprising a plurality of fiberglass strands substantially held together by friction;
a second fiberglass mat comprising a plurality of fiberglass strands substantially held together by friction; and
at least one adhesive element positioned between the first and second fiberglass mats, for securing the first and second fiberglass mats to each other.

8. An acoustic panel according to claim 7 additionally comprising an outer fiberglass mat comprising a plurality of fibers selected to provide at least one substantially smooth side thereof, said outer fiberglass mat being positioned adjacent to a selected one of the first and second fiberglass mats and secured to said selected fiberglass mat to position said at least one substantially smooth side of the outer fiberglass mat facing away from said selected fiberglass mat.

9. An acoustic panel according to claim 8 in which a first additional adhesive element is positioned between the outer fiberglass mat and said selected fiberglass mat, for securing the outer fiberglass mat and said selected fiberglass mat to each other.

10. An acoustic panel according to claim 9 additionally comprising an outer layer positioned proximal to the outer fiberglass mat with a first selected side thereof facing toward the outer fiberglass mat and a second selected side thereof facing away from the outer fiberglass mat, said second selected side thereof being substantially smooth.

11. An acoustic panel according to claim 10 in which the outer layer is secured to the outer fiberglass mat by a second additional adhesive element.

12. An acoustic panel according to claim 10 in which the outer layer comprises a fiberglass veil.

13. An acoustic panel according to claim 10 additionally comprising a cloth layer secured to the second selected side of the outer layer to provide a substantially uniform exterior surface.

14. An acoustic panel according to claim 13 in which the cloth layer is secured to the outer layer.

15. An acoustic panel for muffling sound, the acoustic panel comprising:
a plurality of fiberglass mats;
a plurality of adhesive elements positioned between said fibreglass mats located adjacent to each other, for securing said adjacent fiberglass mats to each other respectively to form a body portion in which an outer surface of at least one of said fiberglass mats at least partially defines the body portion;
an outer fiberglass mat comprising a plurality of polyfibers, said outer fiberglass mat being located adjacent to a selected one of the fiberglass mats and a first preselected side of said outer fiberglass mat being positioned opposite to the selected one of the fiberglass mats;
a first additional adhesive element positioned between the outer mat and the selected fiberglass mat, for securing the outer mat and the selected fiberglass mat to each other;
an outer layer secured to the outer mat to position a substantially smooth surface thereof facing away from the outer mat; and
a second additional adhesive element positioned between the outer mat and the outer layer, to secure the outer layer to the outer mat.

16. An acoustic panel according to claim 15 additionally comprising a cloth layer face-glued to the substantially smooth surface of the outer layer to provide a substantially uniform exterior surface.

17. An acoustic panel according to claim 15 in which the outer layer comprises a fiberglass veil.

18. A method of forming an acoustic panel for muffling sound, the method comprising:
(a) providing a body portion comprising at least one fiberglass mat;
(b) providing at least one outer layer comprising a fiberglass veil;
(c) securing said at least one outer layer to the body portion to position a substantially smooth surface of the outer layer facing away from the body portion.

19. A method of forming an acoustic panel for muffling sound, the method comprising:
(a) providing at least one outer mat comprising a selected side thereof, said outer mat comprising at least one material selected to provide said selected side with a substantially smooth finish; and
(b) securing an outer layer to said selected side of said at least one outer mat to position a substantially smooth surface of the outer layer facing away from the outer mat.

20. A method according to claim 19 additionally comprising:
(c) heating said at least one outer mat and the outer layer to at least partially melt said at least one material, to provide the substantially smooth finish of said selected side.

21. A method according to claim 20 additionally comprising:
(d) attaching a cloth layer to said substantially smooth surface of the outer layer to provide a substantially uniform exterior surface thereof.

22. A method of forming an acoustic panel for muffling sound, the method comprising:
(a) providing a plurality of fiberglass mats;
(b) arranging said fiberglass mats in a layered relationship to locate said fiberglass mats in substantially parallel relationships to each other;
(c) positioning a plurality of adhesive elements between said fiberglass mats respectively, for securing each said fiberglass mats together in the layered relationship to provide a body portion of the acoustic panel;
(d) including an outer mat in the body portion, the outer mat comprising at least one material selected to provide a selected side of the outer mat with a substantially smooth finish;
(e) positioning the outer mat such that said selected side at least partially defines the body portion.

23. A method according to claim 22, additionally comprising:
(f) providing an outer layer comprising a fiberglass veil; and
(g) positioning an additional adhesive element between the outer layer and said selected side of the outer mat to secure the outer layer to the outer mat to locate a substantially smooth surface of the outer layer facing away from the outer mat.
